(19) United States
(12) Patent Application Publication
(10) Pub. No.: US 2026/0349402 A1
(43) Pub. Date: Nov. 5, 2026

(54) TOOLLESS ACCESS TO LOGIC OPERATION OF A PROCESS CONTROLLER

(71) Applicant: Schneider Electric Systems USA, Inc., Foxborough, MA (US)

(72) Inventor: James Redmond, Richmond (CA)

(73) Assignee: Schneider Electric Systems USA, Inc., Foxborough, MA (US)

(21) Appl. No.: 19/195,864

(22) Filed: May 1, 2025

(51) Int. Cl. G05B 19/05

(52) U.S. Cl. CPC G05B 19/056; G05B 2219/13004

(57) ABSTRACT

A method for accessing control logic of a process controller includes receiving, at the controller, an initiation request signal as a request to access the control logic. The controller is configured, in response to the request signal, to generate one or more multimedia artifacts associated with points in the control logic. The method also includes publishing the artifact(s) as a published artifact set, e.g., image files, video files, and/or sound files descriptive of the point(s) in the control logic. The controller includes a processor and memory on which is recorded the control logic and instructions. Execution of the instructions by the processor causes the controller to perform the method. The controller may include a programmable logic controller (PLC), a remote terminal unit (RTU), a flow computer, or a distributed control system (DCS) controller. Publication may be to a webserver or a file system.

### TECHNICAL FIELD

The present disclosure relates generally to automated methodologies and systems for accessing control logic of a programmable process controller of a type used to control an industrial process.

### BACKGROUND

Modern industrial processes are performed with the assistance of a myriad of operational technology (OT) devices and process controllers. For instance, OT signals from OT input devices in the example form of push buttons, rotary dials, selector switches, limit switches, and sensors may be used to control output states of motors, pumps, valves, relays, contactors, and other OT output devices during the industrial process. The OT devices may collectively move materials or work product through multiple stages of the industrial process.

The configuration and operational functions of the process controller may vary depending on the requirements of the particular industrial process being controlled. For example, the process controller may be configured as a programmable logic controller (PLC), a remote terminal unit (RTU), a distributed control system (DCS), a flow computer, etc. The process controller closely monitors and ultimately controls actions of the OT devices and related process equipment. The process controller may include a human-machine interface (HMI) that facilitates direct interaction between the various OT devices and a human operator, for instance to monitor the current or past status of one or more process workstations.

In a representative automated industrial process, one or more processors of the process controller may perform an input scan to read corresponding states of the OT input devices, and execute process logic corresponding to the industrial process. During a subsequent output scan, the processor updates the states of the above-summarized OT output devices and manages communication tasks, including transmission, receipt, and processing of messages, alerts, fault codes, and other information.

### SUMMARY

The present disclosure is directed toward automated methodologies and systems for enabling a human user during an industrial process, e.g., an operator, to access control logic of a programmable process controller. Access to the control logic is provided without using a specialized programming tool, i.e., “toollessly”. The control logic may be executed by one or more processors of the process controller to control the industrial process, for example a manufacturing/assembly process, a drilling or pumping operation, a pipeline operation, etc.

The present hardware and software solutions allow the user to view, monitor, and optionally debug the control logic without the need for a personal computer or laptop running bespoke software. Instead, the user may use a portable user device such as a smartphone, a tablet computer, or a wearable device to perceive aspects of the control logic, whether past or present. The user is thus able to determine if a need exists for consultation with an automation engineer when making a programming adjustment, or to assess if other operational adjustments may be required.

In accordance with a representative embodiment, a method may include receiving an initiation request signal at a process controller running control logic as part of an industrial process. The initiation request signal may include an automatically-generated or a user-initiated request to publish a multimedia representation of one or more aspects of the control logic. In response to the initiation request signal, the method may include configuring the process controller to automatically generate and publish one or more multimedia artifacts as a published artifact set. Each multimedia artifact of the published artifact set is represented herein as one or more still images, image sequences/videos, and/or sound files providing information that is perceivable by a human user. Each artifact in turn is uniquely associated with a corresponding point or points in the aforementioned control logic. The method further includes publishing the multimedia artifact(s) as the published artifact set, thus representing the aspect(s) of the control logic.

The point(s) in the control logic may optionally include state changes in one or more modeled operational technology (OT) devices or other equipment used to perform the industrial process.

Embodiments of the present method may include transmitting the published artifact set to an external user device such as a smartphone or tablet computer. This action, which may occur in response to receiving an access request signal at the process controller, causes a representation of the published artifact set to be presented via the external user device as an operational status of the industrial process.

The method may include dynamically updating the operational status as a dynamically updated current operational status. In such an implementation, the multimedia representation may cause the external user device to present the operational status as the dynamically updated current operational status, for instance by displaying a still image, video sequence with or without supporting sound effects.

Optionally, the initiation request signal may originate from the external user device or another user interface that is separate from and in operable communication with the process controller, for instance in response to user-configurable conditions or other predetermined conditions. Alternatively, the method may include automatically generating the initiation request signal via the process controller, possibly in response to a predetermined triggering event during a past or present performance of the industrial process, or in accordance with one or more user-configurable conditions.

In one or more representative embodiments, the action of generating the initiation request signal using the process controller includes using a programmable logic controller (PLC), a remote terminal unit (RTU), a flow computer, or a distributed control system (DCS) controller to generate the initiation request signal.

Publishing the multimedia artifacts as the published artifact set may include either (or both) of recording the published artifacts in a user-accessible file system, for instance within a computer-readable storage medium/memory of the process controller, or transmitting the published artifact set to a webserver, and ultimately to a web browser of the user device, via a communication interface of the process controller.

The method optionally includes enabling a modification to one or more aspects of the control logic by the user device in response to a debugging request signal.

Another aspect of the disclosure includes a process controller configured to operate during an industrial process. The process controller includes a processor and a computer-readable storage medium, i.e., memory, on which is recorded instructions and control logic for performing the industrial process. Execution of the instructions by the processor causes the process controller to receive an initiation request signal comprising a request to represent (visually display and/or audibly broadcast) one or more aspects of the control logic. The process controller also generates one or more multimedia artifacts in response to the initiation request signal. Each respective one of the multimedia artifacts in this non-limiting embodiment is associated with a corresponding predetermined point (or points) in the control logic.

Execution of the instructions also causes the processor to publish the plurality of multimedia artifacts in a predetermined location as a published artifact set. The published artifact set may include one or more still images, image sequences/videos, and/or sound effects as noted above. As with the above-summarized embodiment, the process controller may be optionally configured as a PLC, an RTU, a flow computer, or a DCS controller. The predetermined location may include a webserver or a user-accessible file system within the memory, with access to the predetermined location by the user device possibly occurring using a web browser of the user device.

The above summary is not intended to represent every embodiment or aspect of the present disclosure. Rather, the foregoing summary includes examples of certain novel aspects and features as set forth herein. The above noted and other features and advantages of the present disclosure will be readily apparent from the following detailed description of representative embodiments and modes for carrying out the present disclosure when taken in connection with the accompanying drawings and the appended claims.

### BRIEF DESCRIPTION OF THE DRAWINGS

The drawings described herein are for illustrative purposes only, are schematic in nature, and are intended to be examples rather than limit the scope of the disclosure.

FIG. 1 illustrates a system for controlling an industrial process in accordance with the present disclosure.

FIG. 2 is flow chart illustrating a method for accessing control logic of a programmable process controller of the system shown in FIG. 1.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

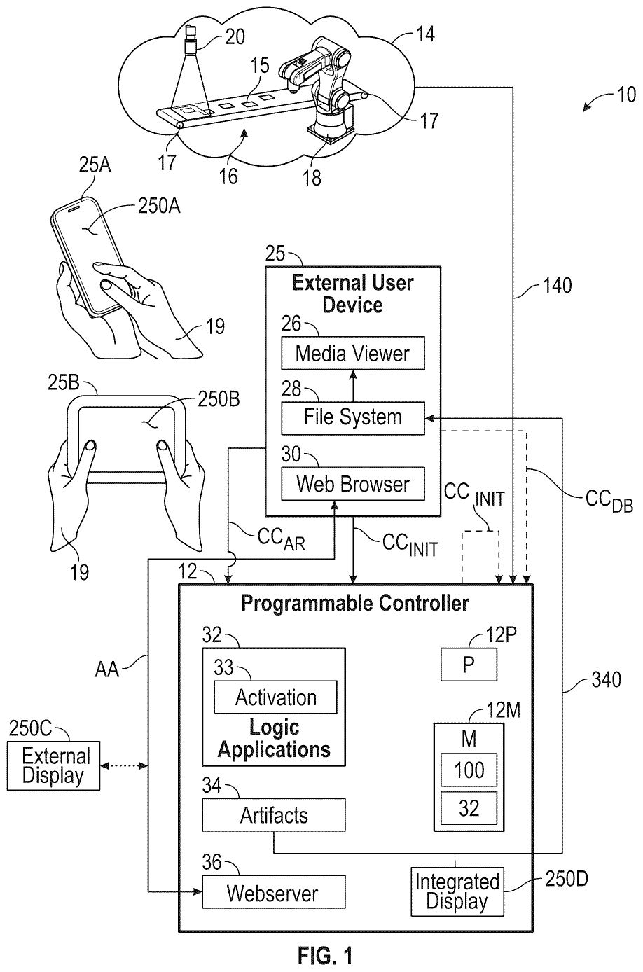

Referring to the drawings, wherein like reference numbers refer to the same or similar components throughout the several views, FIG. 1 illustrates a system 10 having a process controller 12 configured to monitor and control an industrial process 14. The particular construction of the process controller 12 may vary within the scope of the disclosure. Representative/example constructions may include a programmable logic controller (PLC), a self-contained remote terminal unit (RTU) for use in distant oil fields and other remote locations having potentially harsh operating environments, a flow computer, e.g., for monitoring flow of a gaseous or liquid fluid, or a distributed control system (DCS) controller for plant-level or multi-process monitoring and control, without limiting the process controller 12 to such constructions.

In the simplified example shown in FIG. 1, the industrial process 14 is performed using several operational technology (OT) devices including a conveyor 16 powered via motorized drive units 17, e.g., rollers or drive gears. Work product 15 in this example is moved relative to an automation robot 18 and an overhead sensor 20, for instance a camera or a proximity sensor. The complexity, function, and construction of the various OT devices used to perform the industrial process 14 may vary within the scope of the present disclosure, for instance as a manufacturing or assembly process, a drilling or pumping operation, a pipeline operation, etc. Therefore, the simplified industrial process 14 as illustrated in FIG. 1 is intended to be representative and non-limiting of the present teachings.

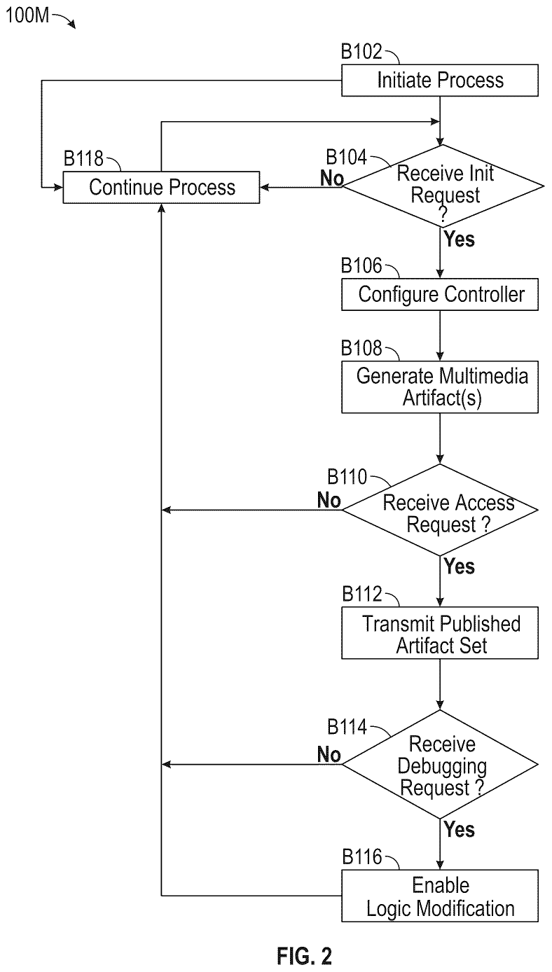

The process controller 12 includes a (i.e., at least one) processor (P) 12P and a computer-readable storage medium (“memory”) 12M on which is recorded a software logic application or control logic 32 for the industrial process 14, and a set of instructions 100. Execution of the instructions 100 by the processor 12P causes the process controller 12 to perform a method 100M (see FIG. 2) and function as set forth herein, with access to the control logic 32 ultimately being made available to a user 19 via an external user device 25. The user 19 may be physically present on site with the process controller 12, or the user 19 may connect remotely over a secure communication network. As noted above, the user device 25 may be configured as a smartphone 25A having a touch screen display 250A or a tablet computer 25B having a touch screen display 250B in two possible configurations. Additionally, the process controller 12 may be in operable communication with an external touch screen display (“External Display”) 250C and/or the process controller 12 may include an integrated touch screen display (“Integrated Display”) 250D. Other constructions of the user device 25 may be used within the scope of the disclosure, including but not limited to televisions, display monitors, wearable computer devices such as smartwatches, etc.

The external user device 25 may be equipped with a media viewer 26, a file system 28 (possibly as part of an accessible database) operable for controlling the manner in which one or more multimedia artifacts 34 in the form of one or more still images, where a sequence of such still images/video, sound effects, or other information perceivable by the user 19 are stored and accessed, and a web browser 30 or other application or module that is configured for enabling access and display of the multimedia artifacts on a local web page, on the Internet, on a local or proprietary network, or via any other appropriate way to display the information in a way that is perceivable by the user 19 and/or which is sharable outside of the external user device 25. For example, the media viewer 26 may be embodied as an application (“app”) or interface operable for displaying the multimedia artifacts 34 via the touch screen display 250A or 250B. Although shown schematically in FIG. 1 for illustrative simplicity, the media viewer 26 may be equipped with playback control, zoom/crop tools, and other handles that allow the user 19 to perceive the multimedia artifacts 34 in a particular manner. Publishing of the multimedia artifacts 34 as a published artifact set 340 may therefore include transmitting the published artifact set 340 to at least one of the media viewer 26 of the external user device 25 using the webserver 36 of the process controller 12, a display such as the external touchscreen display 250C of FIG. 1 that is in operable communication with the process controller 12, or an integrated display in the processor controller 12, for instance the integrated display screen 250D shown in FIG. 1.

In terms of the “toolless” operation of the system 10, the process controller 12 of FIG. 1 operates in accordance with a corresponding standard, as is typical for programmable process controllers. For instance, the process controller 12 may be implemented as a programmable logic controllers or PLC that is programmed with various automation languages, with each language in turn being defined at present by the International Electrotechnical Commission (IEC) 61131-3 standard. PLC languages in particular under IEC 61131-3 include text-based languages, structured text and instruction lists, and graphical languages such as ladder logic, functional block diagrams, and sequential function charts. The IEC 61499 standard for its part extends the scope of IEC 61131-3 to distributed automation systems and event-driven methodologies, for instance Distributed Control System (DCS) platforms commonly used to support petrochemical, oil and gas, power generation, and pharmaceutical processes. Other standards may now (or in the future) be implemented to standardize operation of PLCs, DCSs, and other programmable process controllers.

Using commercially available programming tools such as ECOSTRUCTURE® Control Expert, ECOSTRUCTURE® Automation Expert (EAE), or TELEPACE® Studio (all of which are available from Schneider Electric Corporation of Rueil-Malmaison France), a user such as the user 19 of FIG. 1 can perceive ongoing/real-time operation of the control logic 32 of the process controller 12 during performance of the industrial process 14. However, when the user 19 lacks access to specialized programming tools for interfacing with the process controller 12, typically using bespoke software, the user 19 may be limited to inferring operation of a given logical operation. For instance, the user 19 may observe output values to a particular input/output point, or to a human-machine interface (HMI), supervisory control and data acquisition (SCADA) system, or other user tool.

The solutions of the present application are therefore intended to help the user 19 avoid undue delay, interoperability concerns, and costs typically associated with restricted, tool-based access to the control logic 32. Instead, the process controller 12 of FIG. 1 is configured to selectively publish representative images, image sequences/video, and sound effects-collectively “multimedia artifacts”—to intuitively represent aspects of the control logic 32. Once the multimedia artifacts have been published, the user 19 is free to perceive the represented aspects of the control logic 32 via the user device 25. The present solutions thus offer a more accessible and intuitive solution for the user 19, for instance line technicians, maintenance personnel, and operators.

The process controller 12 illustrated schematically in FIG. 1 is configured to receive (or, in some embodiments, self-generate) an initiation request signal, CC_{INIT}, as a wireless digital or analog communication signal. The term “signal” as used herein refers to a physically discernible indicator configured to convey information, and may be any suitable waveform, e.g., electronic, electrical, optical, magnetic, mechanical or electromagnetic, such as DC or AC, sinusoidal wave, triangular wave, square wave, vibration, and the like, that is capable of traveling through a medium, including wirelessly in the various described embodiments as set forth herein. For example, the user device 25 may communicate with the process controller 12 using Wi-Fi, cellular, BLUETOOTH®, etc. The initiation request signal CC_{INIT} as used herein is any analog or digital request to visually (and possibly audibly) represent aspects of the control logic 32 in preparation for present or future access by the user 19 of the external user device 25.

The process controller 12 may include an activation block 33 that may be turned on or off as needed to enable the described functions. The publishing function in particular may be active all the time or only some of the time, for instance when enabled in the activation block 33 and activated by the user device 25. For instance, when the activation block 33 is turned on, the process controller 12 may generate one or a plurality of (i.e., two or more of) the multimedia artifacts 34. This action may occur in response to the initiation request signal CC_{INIT}. Each respective multimedia artifact 34 is associated with a corresponding predetermined operating point or points in the control logic 32. As noted above, the multimedia artifacts 34 may include one or more still images, a sequence of such still images/video, and/or sound files for creating sound effects, collectively corresponding to execution of the control logic 32. The multimedia artifacts 34 may be variously represented as graphics files such as .png, .jpg, .gif, etc., video files such as .avi, .mpg, or .mp4, and/or sound files such as .mp3, . wav, etc. In certain embodiments, the multimedia artifacts 34 also may be embedded or otherwise included within other types of files; for example, a document file that has embedded or included within it an image or other graphics file.

As part of its programmed functionality, the process controller 12 of FIG. 1 is configured to publish the multimedia artifact(s) 34 in a predetermined location as the published artifact set 340. The predetermined location may include, for instance, a remote or local webserver 36 and/or a user-accessible file system 28, the latter of which may be recorded in memory (not shown) of the user device 25 as shown, the memory 12M of the process controller 12, and/or another accessible location, for instance a cloud-based server. The webserver 36 may be embodied as a software component permitting the process controller 12 to host one or more web pages for presenting the multimedia artifacts 34. The webserver 36 may also permit the user device 25 to remotely access such web pages via the web browser 30, e.g., via a two-way communication channel AA, for instance using a suitable protocol such as Hypertext Transfer Protocol (HTTP) or Hypertext Transfer Protocol Secure (HTTPS).

Execution of the set of instructions 100 by the processor 12P of FIG. 1 causes the process controller 12 to perform various other functions. One such function is to transmit a representation of the published artifact set 340 to the external user device 25, for instance using the Secure File Transfer Protocol (SFTP). This action may occur in response to receipt of an access request signal CC_{AR} from the external user device 25. The representation is configured to cause the external user device 25 to display a past or present operational status of the industrial process 14 associated with the one or more predetermined points in the control logic 32, for instance state changes in one or more modeled devices or one or more actions of the control logic 32. Execution of the instructions 100 may also cause the process controller 12 to dynamically update the operational status as a dynamically updated current operational status.

In a possible implementation, the process controller 12 may also receive a debugging request signal CC_{DB} from the external user device 25. Upon receipt of the debugging request signal CC_{DB}, the process controller 12 may selectively enable the user 19 to modify one or more aspects of the control logic 32. Debugging may include identifying, isolating, and resolving performance problems, logical errors. or other issues in the control logic 32 when troubleshooting possible faults in the industrial process 14.

Referring to FIG. 2, the method 100M may be performed by the process controller 12 of FIG. 1 to enable the user 19 to access representations of the control logic 32 of the process controller 12. The method 100M is described in terms of algorithm code segments or logic blocks for illustrative clarity, with each block of the method 100M being executable by the processor 12P of FIG. 1 before, during, or after performance of the industrial process 14.

The method 100M in accordance with an example embodiment commences at block B102 (“Initiate Process”) upon initiation of the industrial process 14 and subsequent enablement of the method 100M, with the latter action possibly occurring via the above-described activation block 33 (FIG. 1). The method 100M proceeds to block B104 once the industrial process 14 has been initiated.

At block B104 (“Receive Init Request?”), the process controller 12 determines whether the initiation request signal CC_{INIT} has been received at the process controller 12. The initiation request signal CC_{INIT} may originate from a user interface, e.g., the external user device 25 of FIG. 1, that is separate from and in operable communication with the process controller 12. Alternatively, the initiation request signal CC_{INIT} may be automatically generated by the process controller 12 in accordance with one or more predetermined conditions, for instance in accordance with user-configurable conditions that may be optionally selected via an app using the external user device 25 in one or more embodiments. For example, user-configurable conditions may include specific triggering events, faults, or other process events, with such user-configurable conditions possibly being selected from a menu of options using the external user device 25.

The initiation request signal CC_{INIT} may include an analog or digital request for the process controller 12 to represent one or more aspects of the control logic 32 of FIG. 1, possibly in preparation for access to the control logic 32 by the user 19. The method 100M proceeds to block B106 when the initiation request signal CC_{INIT} has been received at the process controller 12. The method 100M proceeds in the alternative to block B118 when the initiation request signal CC_{INIT} has not been received at the process controller 12.

At block B106 (“Configure Controller”), the method 100M includes configuring the process controller 12 in response to the initiation request signal CC_{INIT}. Configuration at block B106 entails automatically generating at least one multimedia artifact 34 (FIG. 1) associated with a corresponding point or points in the control logic 32. The method 100M thereafter proceeds to block B108.

Block B108 (“Generate Multimedia Artifacts”) includes generating one or more representations of the control logic 32 as multimedia artifacts 34, e.g., one or more image files, video files, and/or sound files representative of the point or points in the control logic 32. The multimedia artifacts 34 allow the user 19 to intuitively perceive the operation or state changes of OT devices and other equipment used to perform the industrial process 14.

Upon generation, the process controller 12 may publish the at least one multimedia artifact 34 as the published artifact set 340 of FIG. 1, and temporarily record the one or more multimedia artifacts 34 to a predetermined location, e.g., the memory 12M or another storage location. Publishing as used herein may include recording the published artifact set 340 in a user-accessible file system within the memory 12M of the process controller 12 and/or transmitting the published artifact set 340 to the remote media viewer 26 via a communication interface of the process controller 12, for instance over the communication channel AA.

Optionally, the process controller 12 may dynamically update the operational status of the industrial process 14 as a dynamically updated current operational status. The representation in this instance may be configured to cause the external user device 25 to display the operational status of the industrial process 14 as the dynamically updated current operational status. The method 100M thereafter proceeds to block B110.

At block B110 (“Receive Access Request?”), the process controller 12 determines whether it has received the access request signal CC_{AR} from the user device 25 of FIG. 1. The access request signal CC_{AR} is indicative of a request by the user 19 to view, hear, or otherwise perceive the published artifact set 340. The method 100M proceeds to block B112 when the process controller 12 has received the access request signal CC_{AR}. The method 100M proceeds in the alternative to block B118 when the process controller 12 ascertains that received the access request signal CC_{AR}.

At block B112 (“Transmit Published Artifact Set”), the method 100M of FIG. 2 includes transmitting the published artifact set 340 to the external user device 25. This action occurs in response to receipt by the process controller 12 of the access request signal CC_{AR}, with the access request signal CC_{AR} causing the process controller 12 to create and present a multimedia representation of the published artifact set 340 via the user device 25, e.g., as an operational status of the industrial process 14 being modeled and controlled via the process controller 12. The method 100M thereafter proceeds to block B114.

Block B114 (“Receive Debugging Request?”) entails determining whether the process controller 12 has received the debugging request signal CC_{DB} of FIG. 1. If so, the method 100M proceeds to block B116, with the method 100M proceeding in the alternative to block B118.

Block B116 (“Enable Logic Modification”) includes enabling a modification to one or more aspects of the control logic 32 in response to the debugging request signal CC_{DB}. Once this function has been enabled, the user 19 may perform debugging operations on the control logic 32 to an extent permitted during calibration of the process controller 12. In some implementations, debugging operations may be limited to a specific/predefined set of actions, with more involved debugging efforts or changes to the control logic 32 possibly being reserved for control engineers or other higher-level operators. The method 100M proceeds to block B118 once logic modification has been enabled at block B116.

At block B118 (“Continue Process”), the industrial process 14 of FIG. 1 continues, with the process controller 12 performing its programmed monitoring and control functions. The method 100M returns to block B104.

While several modes for carrying out the many aspects of the present teachings have been described in detail, those familiar with the art to which these teachings relate will recognize various alternative aspects for practicing the present teachings that are within the scope of the appended claims. The above description and accompanying drawings are illustrative and representative of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

Moreover, the present concepts expressly include combinations and sub-combinations of the described elements and features. The detailed description and the drawings are supportive and descriptive of the present teachings, with the scope of the present teachings defined solely by the claims. Words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example.

We claim:

1. A method for accessing control logic of a process controller, the method comprising:
receiving an initiation request signal at the process controller, the initiation request signal comprising a request to access the control logic;
configuring the process controller, in response to the initiation request signal, to generate at least one multimedia artifact that is associated with a corresponding point or points in the control logic; and
publishing the at least one multimedia artifact as a published artifact set, wherein the published artifact set includes one or more image files, video files, and/or sound files representative of the point or points in the control logic.

2. The method of claim 1, further comprising:
transmitting the published artifact set to an external user device in response to an access request signal, wherein the external user device is separate from and in operable communication with the process controller; and
causing a multimedia representation of the published artifact set to be presented via the external user device as an operational status of an industrial process.

3. The method of claim 2, further comprising:
dynamically updating the operational status of the industrial process as a dynamically updated current operational status, wherein the causing the multimedia representation of the published artifact set to be presented via the external user device as an operational status of the industrial process includes causing the multimedia representation of the published artifact set to be presented via the external user device as the dynamically updated current operational status.

4. The method of claim 1, wherein the receiving the initiation request signal at the process controller includes receiving the initiation request signal from an external user device.

5. The method of claim 1, further comprising:
automatically generating the initiation request signal via the process controller in accordance with one or more predetermined conditions.

6. The method of claim 5, wherein the one or more predetermined conditions comprise one or more user-configurable conditions, and wherein automatically generating the initiation request signal via the process controller is performed in accordance with the one or more user-configurable conditions.

7. The method of claim 1, wherein the corresponding point or points in the control logic include state changes in one or more modeled devices of an industrial process.

8. The method of claim 1, wherein the corresponding point or points in the control logic include or one or more actions of the control logic.

9. The method of claim 1, wherein receiving the initiation request signal includes receiving the initiation request signal from an external user device.

10. The method of claim 9, wherein receiving the initiation request signal from an external user device includes receiving the initiation request signal from a smartphone or a tablet computer in operable communication with the process controller.

11. The method of claim 1, wherein the process controller includes a remote terminal unit (RTU), a flow computer, a programmable logic controller (PLC), or a distributed control system (DCS), and wherein receiving the initiation request signal at the process controller is performed by the RTU, the flow computer, the PLC, or the DCS.

12. The method of claim 1, wherein the publishing the multimedia artifacts as the published artifact set includes recording the published artifact set in a user-accessible file system within memory of the process controller.

13. The method of claim 1, wherein the publishing the multimedia artifacts as the published artifact set includes transmitting the published artifacts to at least one of a media viewer of an external user device using a webserver of the process controller, a display in operable communication with the process controller, or an integrated display in the process controller.

14. The method of claim 1, further comprising:
enabling a modification of the control logic in response to receipt of a debugging request signal at the process controller.

15. A process controller configured to operate during an industrial process, the process controller comprising:
a processor; and
a computer-readable storage medium (“memory”) on which is recorded instructions and control logic for the industrial process, wherein execution of the instructions by the processor causes the process controller to:
receive an initiation request signal comprising a request to represent one or more aspects of the control logic;
generate, in response to the initiation request signal, one or more multimedia artifacts, wherein each respective one of the multimedia artifacts is associated with a corresponding predetermined point or points in the control logic; and
publish the one or more multimedia artifacts in a predetermined location as a published artifact set, wherein the published artifact set includes one or more images, videos, and/or sounds, and wherein the process controller includes a programmable logic controller (PLC), a remote terminal unit (RTU), a flow computer, or a distributed control system (DCS) controller, the predetermined location including a web browser or media viewer of an external user device or a user-accessible file system within the memory of the process controller.

16. The process controller of claim 15, wherein the execution of the instructions by the processor causes the process controller to:
transmit to an external user device a representation of the published artifact set, in response to an access request signal, wherein the representation of the published artifact set is configured to cause the external user device to display an operational status associated with the one or more predetermined points in the control logic.

17. The process controller of claim 16, wherein the execution of the instructions by the processor causes the process controller to:
dynamically update the operational status as a dynamically updated current operational status, wherein the representation of the published artifact set is a display of the dynamically updated current operational status.

18. The process controller of claim 16, wherein the execution of the instructions by the processor causes the process controller to:
receive a debugging request signal from the external user device; and
enable a modification of one or more aspects of the control logic by the external user device in response to the debugging request signal.

19. A method for accessing control logic of a process controller configured to operate during an industrial process, the method comprising:
receiving, at the process controller, an initiation request signal from an external user device in communication with the process controller, the initiation request signal comprising a request to access the control logic of the process controller;
configuring the process controller, in response to the initiation request signal, to generate at least one multimedia artifact associated with one or more predetermined points in the control logic; and
publishing the at least one multimedia artifact in a predetermined location as a published artifact set, wherein the published artifact set includes one or more images, videos, and/or sounds, and wherein the predetermined location includes a webserver or a user-accessible file system of the process controller, the process controller including a programmable logic controller (PLC), a remote terminal unit (RTU), a flow computer, or a distributed control system (DCS) controller.

20. The method of claim 19, further comprising:
enabling a modification of one or more aspects of the control logic by the external user device in response to a debugging request signal from the external user device.
